(19) United States
(12) Patent Application Publication
(10) Pub. No.: US 2005/0227183 A1
(43) Pub. Date: Oct. 13, 2005

(54) Compositions and methods for image development of conventional chemically amplified photoresists

(76) Inventors: Mark Wagner, Raleigh, NC (US); James DeYoung, Durham, NC (US)

Correspondence Address: MYERS BIGEL SIBLEY & SAJOVEC, PO BOX 37428, RALEIGH, NC, 27627, US

(21) Appl. No.: 11/088,171

(22) Filed: Mar. 23, 2005

Related U.S. Application Data
(63) Continuation-in-part of application No. 10/045,791, filed on Jan. 11, 2002, now abandoned.

(51) Int. Cl. G03C 5/00

(52) U.S. Cl. 430/311

(57) ABSTRACT

Methods for carrying out lithography with a carbon dioxide development system are described. This invention involves methods for preferential removal of the darkfield region of conventional chemically amplified positive tone resists. The carbon dioxide development systems include a quaternary ammonium salt, preferably a quaternary ammonium halide, borate, sulfonate, tosylate or carbonate. Compositions for carrying out the methods are also described. The quaternary ammonium salts preferably contain at least one CO₂-philic group, such as a siloxane-containing group or a fluorine-containing group.

### RELATED APPLICATIONS

This application is a continuation-in-part of commonly owned, copending application Ser. No. 10/045,791, filed Jan. 28, 2005, the disclosure of which is incorporated by reference herein in its entirety.

### FIELD OF THE INVENTION

The present invention concerns lithographic methods, particularly methods for the preferential removal of dark-field regions which may be used to form patterned regions on substrates such as microelectronic substrates.

### BACKGROUND OF THE INVENTION

In photolithography using chemically amplified resists, the area of photoresist film exposed to incident radiation undergoes a chemical transformation. For most resists systems designed for traditional aqueous base development, this transformation results in a significant increase in polarity. For these systems, traditionally termed positive tone resist systems, the exposed region is removed during development in aqueous base. Alternatively, for negative tone resists systems the exposed region becomes less polar, and/or increases in molecular weight through cross-linking reactions upon exposure to radiation making this region less soluble in the developer solution. For negative tone systems the non-exposed region is preferentially removed in the developer solution.

Aqueous solutions of tetramethyl ammonium hydroxide TMAH are typically used as the photoresist developer. In order for development in aqueous base to be effective, the base must deprotonate a certain number of Bronsted acid groups to allow the resist to become soluble. The amount of deprotonation required for photoresist solubility is known as the critical ionization level, and has been well described in the literature (see G. Willson, et al. J. Vac. Sci. Technol. B 20(2) Mar/Apr 2002, 537-543).

Feature sizes on microelectronic devices continue to shrink as these devices become smaller, faster and more powerful. The lithographic development of these smaller feature sizes in aqueous base can become problematic due to image collapse caused by the capillary forces and surface tension of water. Current approaches to solving this problem include IPA vapor drying and bilayer resist technology. The prevention of image collapse in supercritical CO₂ dryers for MEM's and other applications is based on the absence of surface tension in supercritical CO₂ to avoid surface tension and capillary forces. Each of these potential solutions for image collapse requires additional steps in the lithographic process leading to higher cost of ownership and decreased device yield.

Non-smooth edges on developed features become problematic as feature sizes get smaller (Semiconductor International; February 2005; p. 44). The roughness of a single edge is known as Line Edge Roughness (LER) and the roughness of a feature defined by two edges is known as Line Width Roughness (LWR). Current approaches to minimizing LER/LWR include modification of the photoresist, back anti-reflection coating (BARC) or etch chemistry, or use of a hardmask. All of these approaches generally result in decreased imaging and/or etch performance of the resist, or require additional process steps that increase cost of ownership and decrease device yield. Densified CO₂ has the ability to penetrate and swell certain amorphous polymers. This facilitates delivery of chemistry into the swollen polymer, and can smooth out surface features. Under proper conditions, these properties can be used in lithography to smooth surfaces without affecting the critical dimensions of a feature.

Commercially available photoresists used for 248-nm lithography, 193-nm lithography, e-beam lithography, and those being developed for EUV-based lithography are not soluble in liquid or supercritical carbon dioxide in the exposed or unexposed state making CO₂-based development extremely challenging. Furthermore, Bronsted bases such as TMAH are neutralized in supercritical carbon dioxide which acts as a weak acid. As such, a pH above 7 is not readily accessible in CO₂ based systems. Under these conditions, the minimum level of ionization needed to dissolve exposed positive tone photoresist is not achievable.

In carbon dioxide solvent systems, low-polarity polymer species, specifically fluorinated polymers and siloxane-containing polymers are more soluble than polar polymers. This provides an obvious pathway for negative tone image development, as seen in U.S. Pat. No. 5,665,527 to Allen and U.S. Pat. No. 6,379, 874 to Ober. However, for Allen and Ober, image transfer in the negative tone using dense CO2 utilizes non-commercial and in some cases impractical fluorinated or siloxane-containing polymers that are not proven resist systems and are unlikely to be adopted by the microelectronics industry.

Carbon dioxide based development systems that are compatible with traditional 248-nm, 193-nm, 157-nm, e-beam and EUV resists and leverage the physical properties of CO₂ as a processing fluid to give reduced image collapse and decreased LER/LWR are desirable.

### SUMMARY OF THE INVENTION

A first aspect of the invention is a method for carrying out lithography with a carbon dioxide development system, comprising the steps of: (a) providing a substrate (e.g., a microelectronic substrate), the substrate having a resist layer formed thereon (the resist layer typically comprising a polymer and a photoacid generator), (b) exposing at least one portion of the resist layer to radiant energy causing a chemical shift to take place in the exposed portion and thereby form at least one light field region in the resist layer while concurrently maintaining at least one portion of the resist layer unexposed to the radiant energy (e.g., EUV light) to thereby form at least one dark field region in the polymer resist layer; (c) optionally baking the resist layer; and then (d) contacting the resist layer to a carbon dioxide solvent system (e.g., a liquid or supercritical fluid), the solvent system comprising or consisting essentially of carbon dioxide having a quaternary ammonium salt dispersed therein, under conditions in which the at least one dark field region is preferentially removed from the substrate by the carbon dioxide solvent system as compared to the at least one light field region.

A further aspect of the invention is a method for reducing image collapse during development of a resist layer with a carbon dioxide development system, comprising the steps of: (a) providing a substrate, the substrate having a resist layer formed thereon, the resist layer comprising a polymer and a photoacid generator, wherein the polymer is insoluble in carbon dioxide; (b) exposing at least one portion of the resist layer to radiant energy causing a chemical shift to take place in the exposed portion and thereby form at least one light field region in the resist layer while concurrently maintaining at least one portion of the resist layer unexposed to the radiant energy to thereby form at least one dark field region in the resist layer; (c) optionally baking the resist layer; and then (d) contacting the resist layer to a carbon dioxide solvent system, the solvent system comprising carbon dioxide having a quaternary ammonium salt dispersed therein, under conditions in which the at least one dark field region is preferentially removed from the substrate by the carbon dioxide solvent system as compared to the at least one light field region.

A further aspect of the invention is a method for reducing Line Edge Roughness (LER) and Line Width Roughness (LWR) of a resist layer with a carbon dioxide development system, comprising the steps of: (a) providing a substrate, the substrate having a resist layer formed thereon, the resist layer comprising a polymer and a photoacid generator, wherein the polymer is insoluble in carbon dioxide; (b) exposing at least one portion of the resist layer to radiant energy causing a chemical shift to take place in the exposed portion and thereby form at least one light field region in the polymer resist layer while concurrently maintaining at least one portion of the polymer layer unexposed to the radiant energy to thereby form at least one dark field region in the polymer resist layer; (c) optionally baking the resist layer; and then (d) contacting the resist layer to a carbon dioxide solvent system, the solvent system comprising carbon dioxide having a quaternary ammonium salt dispersed therein, under conditions in which the at least one dark field region is preferentially removed from the substrate by the carbon dioxide solvent system as compared to the at least one light field region.

A further aspect of the invention is a method for reducing Line Edge Roughness (LER) and Line Width Roughness (LWR) of a, developed resist layer, comprising the steps of: (a) providing a substrate, the substrate having an imaged and developed resist layer formed thereon, the resist layer comprising a polymer and a photoacid generator, wherein the polymer is insoluble in carbon dioxide, (b) contacting the resist layer to a carbon dioxide solvent system, the solvent system comprising carbon dioxide having a quaternary ammonium salt dispersed therein, so that the LER and LWR are reduced.

A further aspect of the invention is a carbon dioxide solvent system useful in carrying out a method as described above. In general the system comprises or consists essentially of carbon dioxide (e.g., as a liquid or supercritical fluid) having a quaternary ammonium salt dispersed therein. The quaternary ammonium salt is preferably selected from the group consisting of quaternary ammonium hydroxides, halides, alkoxides, borates, cyanates, carbonates, nitrates, sulfonates, sulfates, tosylates, antimonates, arsenates, halogenates, cyanides, nitrates, nitrites, thiocyanates, etc. In some embodiments the quaternary ammonium cation is a quaternary ammonium hydroxide; in some embodiments the quaternary ammonium salt is not a quaternary ammonium hydroxide; in some embodiments the quaternary ammonium salt is a quaternary ammonium halide; in some embodiments the quaternary ammonium salt is a quaternary ammonium carbonate; in some embodiments the quaternary ammonium salt is asymmetric. In some embodiments the quaternary ammonium cation has at least one CO₂-philic group coupled thereto. In some embodiments the quaternary ammonium salt is a compound of the formula: (R¹)(R²)(R³)(R⁴)N⁺X⁻, wherein: R¹, R², R³ and R⁴ are each independently selected from the group consisting of Rₒ- and R_{f}-, Rₒ comprises an organic group; R_{f} comprises a CO₂-philic group and optionally a non-fluorinated spacer group linking the CO₂-philic group and N; X is selected from the group consisting of hydroxy, halo, carbonate, borates, cyanates, nitrates, sulfonates, sulfates, tosylates, antimonates, arsenates, halogenates, cyanides, nitrates, nitrites, thiocyanates, alkoxy etc.; subject to the proviso that at least one of R¹ through R⁴ is R_{f}. In some embodiments Rₒ comprises an aromatic or aliphatic group; in some embodiments R_{f} comprises perfluoroalkyl or perfluoroaryl; in some embodiments R_{f} comprises an aromatic or aliphatic linking group.

### BRIEF DESCRIPTION OF THE DRAWINGS

FIG. 1 is a schematic illustration of a process of the invention. A chemically amplified photopolymer containing a photo acid generator (C⁺A⁻) is coated onto a semiconductor substrate (A). The substrate is then exposed to electromagnetic radiation of a chosen wavelength through a mask to create “light field” and “dark field” portions in the resist layer (B). Then the substrate is exposed to heat for a defined period to allow acid catalyzed cleavage of protecting groups in the exposed region (C). The substrate is then exposed to a CO₂ fluid containing a developer represented by (R_{f})₂(R)₂N⁺X⁻, producing substrate (D) as a reverse image.

FIG. 2 is a Scanning Electron Microscope (SEM) image of supercritical CO₂ developed DUV photoresist using CO₂-philic ammonium salts.

FIG. 3 is an SEM image of EUV photoresist developed using ammonium salts in supercritical CO₂ showing uncollapsed dense line and space structures with an aspect ratio of 6.9.

FIG. 4 contains SEM images that illustrate the benefit of the described CO₂ based development process for reducing Line Edge Roughnesss (LER) and Line Width Roughness (LWR). FIG. 4a is a top-down image of a dense line and space structure developed with a standard aqueous TMAH process that shows obvious surface roughness on the top and sidewalls. FIG. 4b shows an analogous structure developed with the described CO₂ based process. The structure imaged in 4b has noticeably less surface roughness on the top and sides of the line than the 4a structure.

### DETAILED DESCRIPTION OF THE PREFERRED EMBODIMENTS

The present invention is explained in greater detail in the specification set forth below. Applicants specifically intend that the disclosures of all United States patent references that are cited herein be incorporated herein by reference in their entirety.

1. Substrates and Coatings.

The present invention may be carried out on a variety of substrates in which lithographic patterning is used to define features during the manufacturing process. As such, the invention may be used in the manufacture of semiconductors, miroelectromechanical devices (MEM's), optoelectronics, etc. The present invention can be carried out on substrates for these devices including silicon, germanium, gallium aresenide, indium phosphide, cadmium sulfide, zinc oxide, etc.

Photochemically active resists may be applied by spin coating from solvent or other suitable technique. The resist typically comprises a polymeric material, and may be a positive-acting resist or a negative-acting resist. Any suitable resist composition can be used in conjunction with the present invention, including but not limited to those described in U.S. Pat. Nos. 6,165,678; 6,103,866; 6,042,997; 5,989,776; 5,922,518; 5,866,304; 5,492,793; 5,443,690; 5,071,730; 4,980,264; and 4,491,628.

The resist preferably comprises or consists essentially of polymer and photoacid generator where the polymer is insoluble in CO₂. In previous cases (for example U.S. Pat. No. 5,665,527 to Allen and U.S. Pat. No. 6,379,874 to Ober), negative tone development of resists that were specifically designed to be developed in CO₂ was claimed. Generally, incorporation of fluorocarbon groups or siloxane-based groups is required to make the prototype, non-conventional resists disclosed by Allen and Ober CO2-philic. These types of resists are not specifically designed to be developed in TMAH (Aqueous base), as are the resists useful in the current invention. Additionally, the prototype fluorinated or siloxane-based resists may or may not have the imaging and etch resistant properties already designed in the conventional non-fluorine, non-siloxane containing resists. The present invention can be used to develop commercially available resists that are designed to be developed in aqueous base. The CO₂ based development process described here can be used on photoresists that are currently being used in industry and have a proven history of performance.

For example, in some embodiments the resist composition includes a photosensitive acid generator, or photoacid generator (preferably an ionic photoacid generator such as an iodonium or sulfonium photoacid generator). Upon exposure to radiation, the radiation-sensitive acid generator generates a strong acid. A variety of photosensitive acid generators can be used in the composition. Generally, suitable acid generators have a high thermal stability (preferably to temperatures greater than 160° C.) so they are not degraded during pre-exposure processing. Suitable acid generators include ionic iodonium sulfonates, e.g., diaryl iodonium (alkyl or aryl) sulfonate and bis-(di-t-butylphenyl)iodonium camphanylsulfonate; aryl (e.g., phenyl or benzyl) triflates and derivatives and analogs thereof, e.g., triphenylsulfonium triflate or bis-(t-butyl phenyl)iodonium triflate; pyrogallol derivatives (e.g., trimesylate of pyrogallol); onium salts such as triarylsulfonium and diaryliodonium hexafluoroantimonates, hexafluoroarsenates, trifluoromethane sulfonates and others; trifluoromethanesulfonate esters of hydroxyimides, alpha,alpha′-bis-sulfonyl-diazomethanes; sulfonate esters of nitro-substituted benzyl alcohols; naphthoquinone-4-diazides; and alkyl disulfones. Other suitable photoacid generators are disclosed in Reichmanis et al. (1991), Chemistry of Materials 3:395. Additional suitable acid generators useful in conjunction with the compositions and methods of the invention will be known to those skilled in the art and/or described in the pertinent literature (see U.S. Pat. No. 6,165,678).

The resist composition may additionally, if necessary or desirable, include customary additives such as dyes, sensitizers, additives used as stabilizers and acid-diffusion controlling agents, coating aids such as surfactants or anti-foaming agents, adhesion promoters and plasticizers.

The resist composition may additionally, if necessary or desirable, include additional materials (known to those skilled in the art) such as antireflective layers. The resist composition may also contain additional materials such as second thin film layers creating multi-layer resist compositions typically used to enhance etch resistance.

2. Quaternary Ammonium Salts.

The quaternary ammonium salts useful in the current invention are as a class soluble in dense carbon dioxide (liquid or supercritical) at pressures between 500 psig and 10000 psig and temperatures between 0° C. and 100° C. Most preferred are salts soluble at pressures between 800 psig and 5000 psig at temperatures between 10° C. and 60° C.

The positively charged ion, represented by the formula R¹R²R³R⁴N⁺ preferably contains at least one organic group that is considered CO₂-philic. CO₂-philic groups can be partially or wholly fluorinated, or can consist of siloxane-based or siloxane-containing substituents. These ‘R_{f}’ group can be aliphatic or aromatic in nature or be combinations of both moieties. Ideally, when the CO₂-philic group R_{f} contains fluorine, the group is attached to the nitrogen center through a non-fluorinated linking group (e.g., R_{f}- is a group of the formula RₐR_{b}-, where Rₐ is a fluorine-containing group and R_{b} is a non-halogenated or non-fluorinated linking group). This is to minimize the inductive effect of fluorinated groups (a very electronegative atom) on the nitrogen. The prototypical CO₂-philic group R_{f}- is represented by the formula RₐR_{b}-, where Rₐ is a perfluoroalkyl, perfluoroether, or perfluoroaryl group, and R_{b} is a linking group, typically a C1-C6 aliphatic (linear, non-linear, branched, non-branched, saturated or non-saturated.), aromatic, or a C1-C6 hydrocarbon group such as —CH₂CH₂CH₂—, where the fluorocarbon group is attached to the linking group and the linking group is attached to the nitrogen such that the nitrogen is not directly attached to the fluorocarbon. In the case where the linking group R_{b} is aromatic, a C6 aromatic group is favored. Preferably, the quaternary ammonium salt contains two or three CO2-philic groups, R¹, R², R³, or R⁴. Additional CO2-philic groups could be utilized such as silicone-based moieties and carbonyl-containing moieties such as acetate, ether carbonate. Typically, and preferably, one or more of the groups attached to the nitrogen is not a CO₂-philic group. Of the non-CO₂-philic groups, R¹ through R⁴, typically one group is a C1-C6 aliphatic or C1-6 hydrocarbon group such as a methyl, ethyl, propyl, butyl, or hexyl group.

The negatively charge ion, represented by the formula X−, is in some embodiments selected from a large group of negatively charged ions. The ion, X−, can be hydroxide, or any atom or group of atoms capable of supporting an extra valence electron. Prototypical examples include: halides, (F, Cl, Br, I), oxides, carbonates, borates, cyanates, alkoxides, sulfides, phosphides, phosphates, tosylates, antimonates, arsenates, halogenates, cyanides, nitrates, nitrites, thiocyanates, sulfonates and other organic and inorganic anions. The anion may or may not contain fluorine or fluorinated substituents.

In one preferred embodiment of the ammonium complex R¹R²R³R⁴N⁺, R¹ is different from R², R³, and R⁴. This causes the cation to be asymmetric. For the ammonium complexes described in this invention, significant property differences for various combinations of cations and anions were observed. For ammonium complexes, low ion pair energy is favored by ions that are large and unsymmetrical (Copenhafer, et al.; J. Am. Chem. Soc.; 1951; 73(10); 4557-4561). Generally, we observed that increasing the size and/or the asymmetry of the component ions of our ammonium complex resulted in greater reactivity. With this understanding, we have determined that ammonium complexes of low ion pair energy are more effective in this invention than those with higher ion pair energies. Preferred ammonium complexes have an ion pair energy that is less than that of (R¹)₂Me₂N⁺Cl⁻, where R¹ is C₃F₇CH₂CH₂CH₂—.

Given that ammonium hydroxide complexes are used in conventional aqueous based resist development, one might expect CO₂-philic ammonium hydroxides to be preferred in this invention. While CO₂-philic ammonium hydroxides have been prepared and found to be somewhat effective in the described CO₂ development process, in fact preferred ammonium complexes do not contain hydroxide anions. Ammonium hydroxides are generally unstable due to facile elimination of the amine through Hoffman elimination. The activity of ammonium hydroxide complexes is also low due to relatively high ion-pair energy. Finally, ammonium hydroxide complexes have poor solubility in CO₂ relative to ammonium complexes containing larger, softer and/or fluorinated anions.

Exemplary CO₂-philic groups may include a fluorine-containing segment or a siloxane-containing segment. The fluorine-containing segment is typically a fluorinated alkane (aliphatic) with between 1 and 20 carbon atoms, branched or non-branched. The fluorine-containing segment may also be aromatic or even polymeric in nature. As used herein, a “fluoropolymer” has its conventional meaning in the art and should also be understood to include low molecular weight oligomers, i.e., those which have a degree of polymerization greater than or equal to two. See generally Banks et al., Organofluorine Compounds: Principals and Applications (1994); see also Fluorine-Containing Polymers, 7Encyclopedia of Polymer Science and Engineering 256 (H. Mark et al. Eds. 2 d Ed. 1985). Exemplary fluoropolymers are formed from monomers which may include fluoroacrylate monomers such as 2-(N-ethylperfluorooctanesulfonamido) ethyl acrylate (“EtFOSEA”), 2-(N-ethylperfluorooctanesulfonamido) ethyl methacrylate (“EtFOSEMA”), 2-(N-methylperfluorooctanesulfonamido) ethyl acrylate (“MeFOSEA”), 2-(N-methylperfluorooctanesulfonamido) ethyl methacrylate (“MeFOSEMA”), 1,1′-dihydroperfluorooctyl acrylate (“FOA”), 1,1′-dihydroperfluorooctyl methacrylate (“FOMA”), 1,1′,2,2′-tetrahydroperfluoroalkylacrylate, 1,1′,2,2′-tetrahydro perfluoroalkylmethacrylate and other fluoromethacrylates; fluorostyrene monomers such as alpha-fluorostyrene and 2,4,6-trifluoromethylstyrene; fluoroalkylene oxide monomers such as hexafluoropropylene oxide and perfluorocyclohexane oxide; fluoroolefins such as tetrafluoroethylene, vinylidine fluoride, and chlorotrifluoroethylene; and fluorinated alkyl vinyl ether monomers such as perfluoro(propyl vinyl ether) and perfluoro(methyl vinyl ether). Copolymers using the above monomers may also be employed. Exemplary siloxane-containing segments include alkyl, fluoroalkyl, and chloroalkyl siloxanes. More specifically, dimethyl siloxanes and polydimethylsiloxane materials are useful. Mixtures of any of the above may be used. See, e.g., U.S. Pat. Nos. 5,866,005; 6,270,531; 6,297,206. In some cases, organic acetates, including highly-acetylated sugars, and ether-carbonate and polyether-carbonates may be used as CO2-philic components.

3. Carbon Dioxide Solvent Systems.

Carbon-dioxide solvent or development systems used to carry out the present invention typically comprise, consist of, or consist essentially of:

(a) a quaternary ammonium salt as described above, typically from 0.1, 0.5% or 1.5% to 10 or 20 percent by weight;

(b) carbon dioxide to balance, typically at least 40, 50 60, or 70 percent;

(c) optionally, where desired, from 0, 0.01, 0.1, 0.5, 1 or 2 percent to 5 or 10 percent or more of surfactant (preferably a CO₂-philic surfactant);

(d) optionally, where desired, from 0, 0.01, 0.1, 1 or 2 to 30, 40 or 50 percent or more of an organic co-solvent; and

(e) optionally, and in some embodiments less preferably, from 0.01, or 0.1 to 2, 5 or 10 percent water (and in other embodiments 0 percent water).

Percentages herein are expressed as percentages by weight unless otherwise indicated.

The composition may be provided as a liquid or supercritical fluid, including cryogenic liquids. Liquid and supercritical carbon dioxide are herein together referred to as “densified” carbon dioxide in accordance with established usage.

The organic co-solvent may be one compound or a mixture of two or more ingredients. The organic co-solvent may be or comprise an alcohol (including diols, triols, etc.) including halogenated aliphatic or aromatic alcohols, ether, hydrofluoroether, perfluoroether, amine, ketone, carbonate, or alkanes, or hydrocarbon, or fluorocarbon (aliphatic or aromatic) The organic co-solvent may be a mixture of compounds, such as mixtures of alkanes as given above, or mixtures of one or more alkanes in combination with additional compounds such as one or more alcohols as described above. (e.g., from 0 or 0.1 to 5% of a C1 to C15 alcohol (including diols, triols, etc.)).

Any surfactant can be used to carry out the present invention, including both surfactants that contain a CO₂-philic group (such as described in PCT Application WO96/27704 or U.S. Pat. No. 5,783,082) linked to a CO₂-phobic group (e.g., a lipophilic group) and surfactants that do not contain a CO₂-philic group (i.e., surfactants that comprise a hydrophilic group linked to a hydrophobic (typically lipophilic) group). A single surfactant may be used, or a combination of surfactants may be used. Numerous surfactants are known to those skilled in the art. See, e.g., McCutcheon's Volume 1: Emulsifiers & Detergents (1995North American Edition) (MC Publishing Co., 175 Rock Road, Glen Rock, N.J. 07452). Examples of the major surfactant types that can be used to carry out the present invention include the: alcohols, alkanolamides, alkanolamines, alkylaryl sulfonates, alkylaryl sulfonic acids, alkylbenzenes, amine acetates, amine oxides, amines, sulfonated amines and amides, betaine derivatives, block polymers, carboxylated alcohol or alkylphenol ethoxylates, carboxylic acids and fatty acids, a diphenyl sulfonate derivatives, ethoxylated alcohols, ethoxylated alkylphenols, ethoxylated amines and/or amides, ethoxylated fatty acids, ethoxylated fatty esters and oils, fatty esters, fluorocarbon-based surfactants, glycerol esters, glycol esters, hetocyclic-type products, imidazolines and imidazoline derivatives, isethionates, lanolin-based derivatives, lecithin and lecithin derivatives, lignin and lignin derivatives, maleic or succinic anhydrides, methyl esters, monoglycerides and derivatives, olefin sulfonates, phosphate esters, phosphorous organic derivatives, polyethylene glycols, polymeric (polysaccharides, acrylic acid, and acrylamide) surfactants, propoxylated and ethoxylated fatty acids alcohols or alkyl phenols, protein-based surfactants, quaternary surfactants, sarcosine derivatives, silicone-based surfactants, soaps, sorbitan derivatives, sucrose and glucose esters and derivatives, sulfates and sulfonates of oils and fatty acids, sulfates and sulfonates ethoxylated alkylphenols, sulfates of alcohols, sulfates of ethoxylated alcohols, sulfates of fatty esters, sulfonates of benzene, cumene, toluene and xylene, sulfonates of condensed naphthalenes, sulfonates of dodecyl and tridecylbenzenes, sulfonates of naphthalene and alkyl naphthalene, sulfonates of petroleum, sulfosuccinamates, sulfosuccinates and derivatives, taurates, thio and mercapto derivatives, tridecyl and dodecyl benzene sulfonic acids, etc.

Particular preferred embodiments of solvent systems that may be utilized herein are described in greater detail below.

4. Development Systems.

In one embodiment of the invention, the polarity of the polymer resist in the light-field region is increased by the radiant energy. In another embodiment of the invention, the molecular weight of the polymer resist in the light-field region is decreased by the radiant energy. These changes are examples of a “chemical switch” or “chemical shift”. Of course, the two processes (increased polarity, decreased molecular weight) may occur concurrently with one another upon exposure of the polymer resist to radiant energy.

Dense phase carbon dioxide, liquid and supercritical CO₂ phases, have solvent properties that are significantly ‘tuneable’ over a large range of pressures and temperatures. Whereas conventional solvents and water may have density changes of <5% over a temperature range of 20° C., the density of liquid and supercritical CO₂ can change dramatically over the same range (e.g., 60% between 35° C. and 55° C. at 125 bar). The changes in fluid density as a function of pressure can also be significant as the pressure of supercritical CO₂ changes. At 55° C., the density of supercritical CO₂ fluid changes 125% between 100 and 200 bar. While fluid density does not completely account for the solubility or phase behavior properties of molecules in CO₂ fluid, it is a generally good indicator.

The current invention discloses a new class of materials and dense carbon dioxide compositions useful in the image development of conventional chemically amplified photoresists in liquid or supercritical carbon dioxide. The development agents are generally defined as quaternary ammonium salts and are specifically CO2-soluble quaternary ammonium salts, or quaternary ammonium salts that are soluble or highly dispersable in predominantly dense CO2 fluids (i.e. the CO2 fluid may contain minority quantities of cosolvents, dispersants, surfactants or mixtures of adjuncts.) Additionally the current invention discloses new methods for image transfer using these agents in dense carbon dioxide to generate reverse tone images from conventional positive tone resists.

In one embodiment, a composition containing dense CO2 and less than 5 mole percent of a CO2-soluble quaternary ammonium salt represented by the formula (R_{f})₂NMe₂⁺X⁻ (where Rf is CF₃CF₂ CF₂ CF₂ CF₂ CF₂ CH₂ CH₂ CH₂ and where X⁻ is I⁻), is used to develop a 248-nm exposed wafer coated with a conventional positive tone DUV photoresist composition. In this case, the CO2 composition removes the non-exposed or “dark-field” region of the resist resulting in what may be termed “image reversal” of a conventionally positive tone resist.

5. Lithography Techniques.

In general, photolithography involves the transfer of a design on a mask to a printed image in resist/photoresist material on a semiconductor substrate. There are a number of commonly recognized physical factors that contribute to differences between the design and the printed image. Lithography is well known and the steps thereof in the context of the present invention may be carried out by any suitable technique, including but not limited to those described in Introduction to Microlithography, Eds. Thompson et al. (Washington, D.C.: American Chemical Society, 1994), and in U.S. Pat. Nos. 6,383,719; 6,162,577; 5,780,188; 5,736,281; and 5,532,090.

In some embodiments, the process for generating a resist image on a substrate comprises the steps of: (a) coating a substrate with a film comprising the resist composition; (b) imagewise exposing the film to radiation/radiant energy; and (c) developing the image with a carbon dioxide solvent system as described herein. The first step involves coating the substrate with a film comprising the resist composition dissolved in a suitable solvent. Suitable substrates include but are not limited to those described above. The substrate may or may not be coated with an organic anti-reflective layer prior to deposition of the resist composition. Preferably, the surface of the substrate is cleaned before the film is deposited thereon. In some embodiments, before the film has been exposed to radiation, the film is heated to an elevated temperature of about 90-150° C. for a short period of time, typically on the order of about 1 minute. In some embodiments the dried film may have a thickness of about 0.1-5.0 microns, or more particularly about 0.2-1.0 microns. In the second step of the process, the film is imagewise exposed to x-ray, electron beam, ultraviolet radiation/light (including deep ultraviolet light and extreme ultraviolet (EUV) light), or other source of radiant energy. The radiation is sufficient to initiate a chemical reaction in the resist film to increase the polarity thereof and/or decrease the molecular weight thereof (e.g., by generating free acid which causes cleavage of an acid-cleavable substituent and formation of the corresponding acid or alcohol or other base soluble functional groups). The carbon dioxide can serve to dilate or swell the polymer resist and hence obviate the need for a post exposure bake step, or a post exposure bake step may optionally be utilized in accordance with known techniques. The third step involves development of the image with a carbon dioxide solvent system as described above, utilizing the solvent systems described herein in a manner that preferentially removes the un-exposed “dark-field” region.

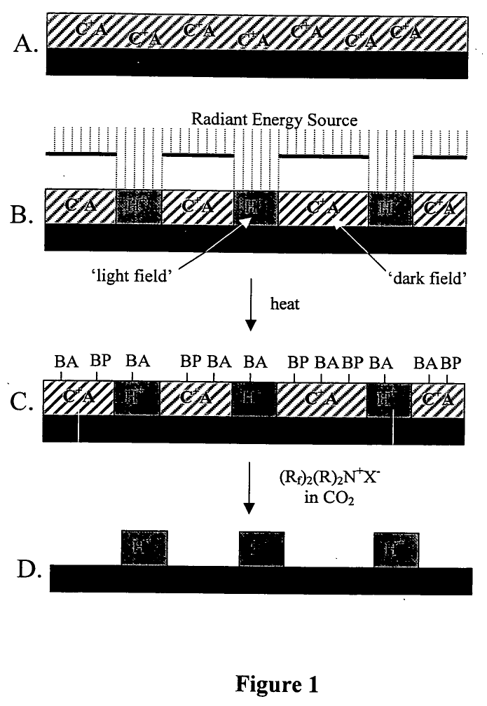

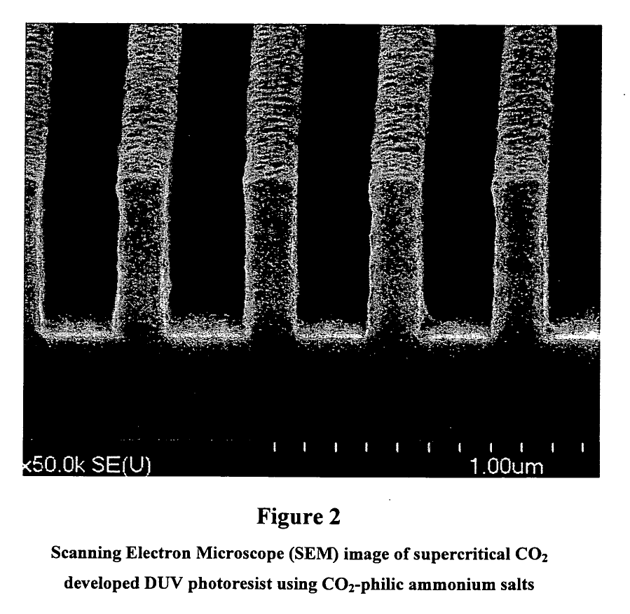

The process, along with a proposed (non-limiting) theory of the invention, is shown in FIG. 1. A chemically amplified photopolymer containing a photo acid generator (C⁺A⁻) is coated onto a semiconductor substrate (panel A). The substrate is then exposed to electromagnetic radiation of a chosen wavelength through a mask to create “light field” and “dark field” portions in the resist layer (panel B). In the next step of the process the substrate is exposed to heat for a defined period in a post-exposure bake (C). The “dark field” polymer resist comprises polymers with Bronsted Acid (BA) functional groups and protected Bronsted Acid (BP) groups. PAG is present in its original state. The ‘light field’ polymer resist comprises polymers with the original Bronsted Acid functional groups plus additional Bronsted Acid functional groups as a result of PAG acid (H+) generated cleavage of protecting groups. PAG in the ‘light field’ is consumed and byproducts are generated. The substrate is then exposed to a CO₂ fluid containing a developer represented by (R_{f})₂(R)₂N⁺X⁻, producing substrate (D) as a “reverse image”. A representative example of a CO₂-developed image using this type of development is seen in FIG. 2.

6. Photoacid Generator as Ion Source for Dark-field Development.

Without wishing to be bound to particular theory related to the mechanistic aspects of the reverse tone development in CO₂ described here, the following discussion is put forward to describe the functions of the novel formulations toward image transfer.

Typical chemically amplified photoresists contain a mixture of protected and unprotected Bronsted acid functionality to enhance solubility in aqueous base. For instance, a DUV resist might contain protected and unprotected hydroxy styrene groups. Following exposure and post-exposure bake, a majority of the protecting groups in the light field region are cleaved to give additional hydroxy styrene functionality in the exposed area. Bronsted acid functionality such as hydroxy styrene can react with the fluorinated ammonium cation to form associative complexes that will enhance solubility in CO₂. Because the exposed areas will contain more Bronsted acid groups, they are likely to form a greater number of associative complexes with the ammonium, relative to the unexposed region, and should thus have greater solubility in CO₂. By this logic, one would expect ammonium complexes in CO₂ to provide normal photoresist development, where the exposed areas are preferentially removed over the unexposed areas. In fact what is observed under these conditions in carrying out the present invention is reverse tone development. Assuming that the basic mechanism of CO₂ dissolution remains Bronsted acid association with the CO₂ soluble ammonium complex, there must be additional factors that favor reverse tone development. Two potential sources are (1) preferential wetting and delivery of CO₂ soluble chemistry to the non-exposed areas due to lower polarity, and (2) interaction of the ammonium salt with PAG in the unexposed area to generate conditions and/or complexes that favor ammonium association with Bronsted acid groups.

Amorphous polymers including photoresist compositions are known to swell in supercritical carbon dioxide as this zero surface tension fluid readily permeates the free-volume voids of the typical polymer matrix (See for example: T. Toga et. al Europhysics Letters, 60 (4) 2002, 559-565). The degree of swelling is dependent on the chemical nature of the polymer and the fluid conditions (P,T). Highly amorphous low-polarity polymers with low cohesive energy densities are known to swell significantly even if they do not dissolve in the dense CO₂. On the other hand, highly polar amorphous polymers with higher cohesive energy densities swell very little in CO2 as non-polar CO2 is incapable of breaking the inter- and intra- chain interactions. Additionally, in the case of the non-polar polymers, the transport of small molecules through the swollen polymer matrix is facilitated dramatically over the non-swollen polar polymer. In the context of a conventional positive tone chemically amplified photoresist, the non-exposed PR remains relatively non-polar as it's chemically active groups are typically protected with somewhat bulky non-polar groups. Conversely, the exposed portion of the positive tone photoresist becomes relatively more polar usually through protective group cleavage initiated by the incident light, photoacid generator, and post exposure bake. The increased polarity of the light field region in positive tone PR makes is much less likely to be affected by densified CO2 solutions due to reduced swelling and inhibited small molecule diffusion. For the non-exposed section of positive tone PR, it is likely to be swollen and affected by any chemistry dissolved in CO2 because it is relatively non-polar. For the invention described here, it is believed that the ammonium complex is significantly more likely to interact with the non-exposed photoresist than the exposed as CO2 is much more suitable to wet and swell the relatively non-polar resist than the more polar exposed and deprotected resist.

Significant changes in reaction rate and/or product distribution may be observed for reactions with ionic complexes in the presence of additional salts. This phenomena is well studied and is known as the “salt effect” (Loupy,et al; Chem. Rev.; 1992; 92(6); 1141-1165). The large majority of photo acid generators (PAG's) are salts consisting of a cation that acts as the chromophore and a weak base anion. In the exposed area of the photoresist, light interacts with the chromophore of the PAG, ultimately leading to decomposition of the salt complex and generation of a strong Bronsted acid from the weak base. During post exposure bake, the PAG acid diffuses throughout the exposed resist and deprotects acid labile protective groups to increase the base solubility of exposed resist relative to non-exposed. In the non-exposed area, the PAG salt remains unchanged. So for a chemically amplified positive tone resist, the contrast between exposed and non-exposed resist is ultimately determined by distribution of the unchanged PAG salt and the PAG acid. In typical development, aqueous base is used to dissolve away the deprotected resist produced by the PAG acid in the exposed region. For the invention described here, we propose that the PAG salt from the non-exposed region interacts with the ammonium complex and/or the Bronsted Acid group in a manner that favors association of the CO2-philic ammonium complex with Bronsted acid groups such as phenols or acrylic acid. This leads to dissolution of the non-exposed region in CO2, giving reverse image development. The precise manner in which the unexposed PAG salt interacts with the ammonium complex to favor association with Bronsted acid groups is unknown. Based on the relative amount of PAG salt contained in the photoresist and the presumed concentration of ammonium cation/Bronsted acid complex required for CO2 solubility, it is likely that the role of the PAG salt is catalytic. Given the increased reactivity observed for ammonium complexes of lower ion-pair energy, it is also possible that ion exchange between the PAG salt and the ammonium complex plays some role.

The present invention is explained in greater detail in the following non-limiting Examples.

### EXAMPLE 1

A chemically amplified positive tone photoresist with photoacid generator is coated onto a substrate and baked to remove residual solvent. The substrate is then exposed to incident light through a pattern transfer mask and then baked to complete hydrolysis of chemically active groups. Reverse image development of the pattern in CO₂ is then accomplished in the following manner. The substrate is placed in a pressure vessel heated to 50 C. On the bottom of the pressure vessel, not in contact with the substrate, is placed 500 mg of (R_{f})₂RₒNMe⁺OH⁻, where Rf is CF₃CF₂CF₂CF₂CF₂CF₂CH₂CH₂ and Rₒ is n-hexyl Carbon dioxide is then added to the pressure vessel to 250 bar. The substrate is held at these pressure and temperature conditions for 15 minutes. A solution of carbon dioxide containing 3 ml of 2,2,3,3,4,4,5,5-octafluoro-1-pentanol is then pushed into the pressure vessel with simultaneous venting to maintain a pressure of 250 bar and a flow rate of 30 ml/min. Pure carbon dioxide is then rinsed through the system for an additional 5 fluid turnovers at 250bar. The chamber is then vented and the substrate is removed to yield the reverse development image of the original pattern.

### EXAMPLE 2

A chemically amplified positive tone photoresist with photoacid generator is coated onto a substrate and baked to remove residual solvent. The substrate is then exposed to incident light through a pattern transfer mask and then baked to complete hydrolysis of chemically active groups. Reverse image development of the pattern in CO₂ is then accomplished in the following manner. The substrate is placed in a pressure vessel at room temperature (23 C). The vessel is then filled with a carbon dioxide solution containing 200 mg of R_{f}FNMe₂⁺OH⁻ (where R_{f}is CF₃CF₂CF₂CF₂CF₂CF₂CH₂CH₂CH₂ and Rₒ is an n-hexyl group) to a pressure of 85 bar. The substrate is held at these pressure and temperature conditions for 5 minutes. A solution of carbon dioxide containing 3 ml of 2,2,3,3,4,4,5,5-octafluoro-l-pentanol is then pushed into the pressure vessel with simultaneous venting to maintain a pressure of 85 bar and a flow rate of 30 ml/min. Pure carbon dioxide is then rinsed through the system for an additional 5 fluid turnovers at 85 bar. The chamber is then vented and the substrate is removed to yield the reverse development image of the original pattern.

### EXAMPLE 3

A chemically amplified positive tone photoresist with photoacid generator is coated onto a substrate and baked to remove residual solvent. The substrate is then exposed to incident light through a pattern transfer mask and then baked to complete hydrolysis of chemically active groups. Reverse image development of the pattern in CO₂ is then accomplished in the following manner. The substrate is placed in a pressure vessel heated to 40 C. On the bottom of the pressure vessel, not in contact with the substrate, is placed 500mg of (R_{f})₂RₒNMe⁺I⁻, where Rf is CF₃CF₂CF₂CF₂CF₂CF₂CH₂CH₂CH₂ and Rₒ is an n-hexyl group. Carbon dioxide is then added to the pressure vessel to 250 bar. The substrate is held at these pressure and temperature conditions for 30 minutes. A solution of carbon dioxide containing 3 ml of 2,2,3,3,4,4,5,5-octafluoro-1-pentanol is then pushed into the pressure vessel with simultaneous venting to maintain a pressure of 250 bar and a flow rate of 30 ml/min. Pure carbon dioxide is then rinsed through the system for an additional 5 fluid turnovers at 250 bar. The chamber is then vented and the substrate is removed to yield the reverse development image of the original pattern.

### EXAMPLE 4

A chemically amplified positive tone photoresist with photoacid generator is coated onto a substrate and baked to remove residual solvent. The substrate is then exposed to incident light through a pattern transfer mask and then baked to complete hydrolysis of chemically active groups. Reverse image development of the pattern in CO₂ is then accomplished in the following manner. The substrate is placed in a pressure vessel heated to 40 C. The vessel is then filled with a carbon dioxide solution containing 150 mg of (Rf)₂NMe₂⁺X⁻ (where R_{f} is CF₃CF₂ CF₂ CF₂ CF₂ CF₂ CH₂ CH₂ CH₂ and X is OC(O)CF₂CF₃) to a pressure of 85 bar. The substrate is held at these pressure and temperature conditions for 2 minutes Pure carbon dioxide is then rinsed through the system for an additional 5 fluid turnovers at 85 bar. The chamber is then vented and the substrate is removed to yield the reverse development image of the original pattern.

### EXAMPLES 5-6

### Reducing Line Edge Roughness and Line Width Roughness

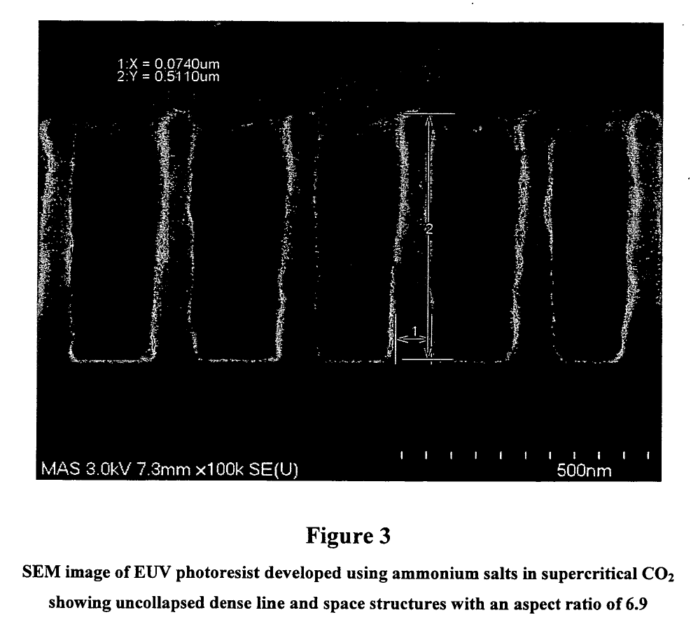

FIG. 3 is an SEM image of EUV photoresist developed using ammonium salts in supercritical CO₂ as described herein, showing uncollapsed dense line and space structures with an aspect ratio of 6.9.

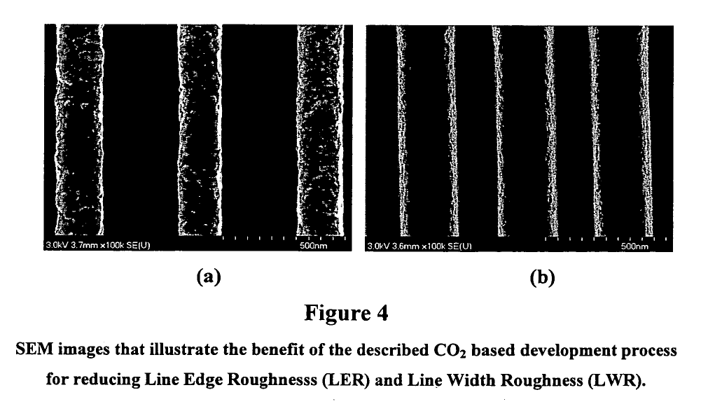

FIG. 4 contains SEM images that illustrate the benefit of the described CO₂ based development process for reducing Line Edge Roughnesss (LER) and Line Width Roughness (LWR). FIG. 4a is a top-down image of a dense line and space structure developed with a standard aqueous TMAH process that shows obvious surface roughness on the top and sidewalls. FIG. 4b shows an analogous structure developed with the described CO₂ based process. The structure imaged in 4b has noticeably less surface roughness on the top and sides of the line than the 4a structure.

The foregoing is illustrative of the present invention, and is not to be construed as limiting thereof. The invention is defined by the following claims, with equivalents of the claims to be included therein.

1. A method for carrying out lithography with a carbon dioxide development system, comprising the steps of:
(a) providing a substrate, said substrate having a resist layer formed thereon, said resist layer comprising a polymer and a photoacid generator, wherein said polymer is insoluble in carbon dioxide;
(b) exposing at least one portion of said resist layer to radiant energy causing a chemical shift to take place in said exposed portion and thereby form at least one light field region in said polymer resist layer while concurrently maintaining at least one portion of said resist layer unexposed to said radiant energy to thereby form at least one dark field region in said resist layer;
(c) optionally baking said resist layer; and then (d) contacting said resist layer to a carbon dioxide solvent system, said solvent system comprising carbon dioxide having a quaternary ammonium salt dispersed therein, under conditions in which said at least one dark field region is preferentially removed from said substrate by said carbon dioxide solvent system as compared to said at least one light field region.

2. The method of claim 1, wherein said photoacid generator is an ionic photoacid generator.

3. The method of claim 1, wherein said photoacid generator is an iodonium or sulfonium photoacid generator.

4. The method of claim 1, wherein said quaternary ammonium salt has an ion pair energy that is less than that of (R¹)₂Me₂N⁺Cl⁻, where R¹ is C₃F₇CH₂CH₂CH₂—.

5. The method of claim 1, wherein said quaternary ammonium salt is a quaternary ammonium hydroxide.

6. The method of claim 1, wherein said quaternary ammonium salt is not a quaternary ammonium hydroxide.

7. The method of claim 1, wherein said quaternary ammonium salt is selected from the group consisting of quaternary ammonium halides, oxides, alkoxides, carbonates, borates, cyanates, alkoxides, sulfides, sulfates, sulfonates, phosphides, phosphates, tosylates, antimonates, arsenates, halogenates, cyanates, nitrates, nitrites, thiocyanates.

8. The method of claim 1, wherein said quaternary ammonium salt is a quaternary ammonium halide.

9. The method of claim 1, wherein said quaternary ammonium salt is a quaternary ammonium carbonate.

10. The method of claim 1, wherein said quaternary ammonium cation has at least one CO₂-philic group coupled thereto.

11. The method according to claim 1, wherein said carbon dioxide solvent system is a liquid.

12. The method according to claim 1, wherein said carbon dioxide solvent system is a supercritical fluid.

13. The method according to claim 1, wherein said substrate is a microelectronic substrate.

14. The method according to claim 1, wherein said radiant energy is EUV light.

15. The method according to claim 1, wherein said radiant energy is 193 nm light.

16. The method according to claim 1, wherein said radiant energy is 248 nm light.

17. The method of claim 1, wherein said quaternary ammonium salt is a compound of the formula: (R¹)(R²)(R³)(R⁴)N⁺X⁻—, wherein:
R¹, R², R³ and R⁴ are each independently selected from the group consisting of Rₒ- and R_{f}-,
Rₒ comprises an organic group;
R_{f} comprises a CO₂-philic group and optionally a non-fluorinated spacer group linking the CO₂-philic group and N;
X is a counterion selected from the group consisting of hydroxy, halo, carbonate, borate, tosylate, sulfate, and antimonate;
subject to the proviso that at least one of R¹ through R⁴ is R_{f}.

18. The method of claim 17, wherein X is hydroxide.

19. The method of claim 17, wherein X is not hydroxide.

20. The method of claim 17, wherein X is selected from the group consisting of halo, carbonate, borate, tosylate, sulfate, and antimonate.

21. The method of claim 17, wherein R¹ is different from R², R³, and R⁴, so that said quaternary ammonium contains an ammonium cation that is asymmetric. .

22. The method of claim 17, wherein Rₒ is an aromatic or aliphatic group.

23. The method of claim 17, wherein R_{f} comprises a perfluoroalkyl or perfluoroaryl group.

24. The method of claim 17, wherein R_{f} further comprises an aromatic or aliphatic linking group.

25. A resist layer development composition for use in photolithography consisting essentially of:
(a) from 0.1 to 20 percent by weight of a quaternary ammonium salt; wherein said quaternary ammonium salt comprises a cation having at least one CO₂-philic group; and wherein said quaternary ammonium salt contains either (i) a cation that is asymmetric or (ii) an anion that is not a hydroxide;
(b) at least 40 percent by weight of carbon dioxide;
(c) from 0 to 10 percent by weight of surfactant;
(d) from 0 to 50 percent by weight of an organic co-solvent; and
(e) from 0 to 10 percent by weight water.

26. The composition of claim 25, wherein said quaternary ammonium salt has an ion pair energy that is less than that of (R¹)₂Me₂N⁺Cl⁻, where R¹ is C₃F₇CH₂CH₂CH₂—.

27. The composition of claim 25, wherein said quaternary ammonium salt is a quaternary ammonium hydroxide.

28. The composition of claim 25, wherein said quaternary ammonium salt is not a quaternary ammonium hydroxide.

29. The composition of claim 25, wherein said quaternary ammonium salt is selected from the group consisting of quaternary ammonium halides, oxides, alkoxides, carbonates, borates, cyanates, alkoxides, sulfides, sulfates, sulfonates, phosphides, phosphates, tosylates, antimonates, arsenates, halogenates, cyanates, nitrates, nitrites, and thiocyanates.

30. The composition of claim 25, wherein said quaternary ammonium salt is a quaternary ammonium halide.

31. The composition of claim 25, wherein said quaternary ammonium salt is a quaternary ammonium carbonate.

32. The composition of claim 25, wherein said quaternary ammonium cation has at least one CO₂-philic group coupled thereto.

33. The composition of claim 25, wherein said carbon dioxide solvent system is a liquid.

34. The composition of claim 25, wherein said carbon dioxide solvent system is a supercritical fluid.

35. The composition of claim 25, wherein said quaternary ammonium salt is a compound of the formula: (R¹)(R²)(R³)(R⁴)NX, wherein:
R¹, R², R³ and R⁴ are each independently selected from the group consisting of Rₒ- and R_{f}-,
Rₒ comprises an organic group;
R_{f} comprises a CO₂-philic group and optionally a non-fluorinated spacer group linking said CO₂-philic group and N;
X is selected from the group consisting of halo, carbonate borate, tosylate, sulfate, and antimonate;
subject to the proviso that at least one of R¹ through R⁴ is R_{f}.

36. The composition of claim 35, wherein R¹ is different from R², R³, and R⁴, so that said quaternary ammonium salt is asymmetric.

37. The composition of claim 35, wherein Rₒ comprises an aromatic or aliphatic group.

38. The composition of claim 35, wherein R_{f} comprises perfluoroalkyl or perfluoroaryl.

39. The composition of claim 35, wherein R_{f} further comprises an aromatic or aliphatic linking group.

40. The composition of claim 35, wherein R_{f} comprises a siloxane-containing group.

41. A method for reducing image collapse during development of a resist layer with a carbon dioxide development system, comprising the steps of:
(a) providing a substrate, said substrate having a resist layer formed thereon, said resist layer comprising a polymer and a photoacid generator, wherein said polymer is insoluble in carbon dioxide;
(b) exposing at least one portion of said resist layer to radiant energy causing a chemical shift to take place in said exposed portion and thereby form at least one light field region in said resist layer while concurrently maintaining at least one portion of said resist layer unexposed to said radiant energy to thereby form at least one dark field region in said resist layer;
(c) optionally baking said resist layer; and then
(d) contacting said resist layer to a carbon dioxide solvent system, said solvent system comprising carbon dioxide having a quaternary ammonium salt dispersed therein, under conditions in which said at least one dark field region is preferentially removed from said substrate by said carbon dioxide solvent system as compared to said at least one light field region.

42. The method of claim 41, wherein said quaternary ammonium salt is a quaternary ammonium hydroxide.

43. The method of claim 41, wherein said quaternary ammonium salt is not a quaternary ammonium hydroxide.

44. The method of claim 41, wherein said quaternary ammonium salt is selected from the group consisting of quaternary ammonium halides, oxides, alkoxides, carbonates, borates, cyanates, alkoxides, sulfides, sulfates, sulfonates, phosphides, phosphates, tosylates, antimonates, arsenates, halogenates, cyanates, nitrates, nitrites, thiocyanates.

45. The method of claim 41, wherein said quaternary ammonium salt contains an asymmetric quaternary ammonium cation.

46. A method for reducing Line Edge Roughness (LER) and Line Width Roughness (LWR) of a resist layer with a carbon dioxide development system, comprising the steps of:
(a) providing a substrate, said substrate having a resist layer formed thereon, said resist layer comprising a polymer and a photoacid generator, wherein said polymer is insoluble in carbon dioxide;
(b) exposing at least one portion of said resist layer to radiant energy causing a chemical shift to take place in said exposed portion and thereby form at least one light field region in said polymer resist layer while concurrently maintaining at least one portion of said polymer layer unexposed to said radiant energy to thereby form at least one dark field region in said polymer resist layer;
(c) optionally baking said resist layer; and then
(d) contacting said resist layer to a carbon dioxide solvent system, said solvent system comprising carbon dioxide having a quaternary ammonium salt dispersed therein, under conditions in which said at least one dark field region is preferentially removed from said substrate by said carbon dioxide solvent system as compared to said at least one light field region.

47. The method of claim 46, wherein said quaternary ammonium salt is a quaternary ammonium hydroxide.

48. The method of claim 46, wherein said quaternary ammonium salt is not a quaternary ammonium hydroxide.

49. The method of claim 46, wherein said quaternary ammonium salt is selected from the group consisting of quaternary ammonium halides, oxides, alkoxides, carbonates, borates, cyanates, alkoxides, sulfides, sulfates, sulfonates, phosphides, phosphates, tosylates, antimonates, arsenates, halogenates, cyanates, nitrates, nitrites, thiocyanates.

50. The method of claim 46, wherein said quaternary ammonium salt contains an asymmetric quaternary ammonium cation.

51. A method for reducing Line Edge Roughness (LER) and Line Width Roughness (LWR) of a, developed resist layer, comprising the steps of
(a) providing a substrate, said substrate having an imaged and developed resist layer formed thereon, said resist layer comprising a polymer and a photoacid generator, wherein said polymer is insoluble in carbon dioxide,
(b) contacting said resist layer to a carbon dioxide solvent system, said solvent system comprising carbon dioxide having a quaternary ammonium salt dispersed therein, so that said LER and LWR are reduced.

52. The method of claim 51, wherein said quaternary ammonium salt is a quaternary ammonium hydroxide.

53. The method of claim 51, wherein said quaternary ammonium salt is not a quaternary ammonium hydroxide.

54. The method of claim 51, wherein said quaternary ammonium salt is selected from the group consisting of quaternary ammonium halides, oxides, alkoxides, carbonates, borates, cyanates, alkoxides, sulfides, sulfates, sulfonates, phosphides, phosphates, tosylates, antimonates, arsenates, halogenates, cyanates, nitrates, nitrites, thiocyanates.

55. The method of claim 51, wherein said quaternary ammonium salt contains an asymmetric quaternary ammonium cation.
